(19) United States
(12) Patent Application Publication
(10) Pub. No.: US 2020/0294406 A1
(43) Pub. Date: Sep. 17, 2020

(54) Aide System of Positioning of an Aircraft, Flying Set Comprising Such a System and Associated Aide Method of Positioning

(71) Applicant: Thales, Courbevoie (FR)

(72) Inventors: Eric Cellerier, Toulouse (FR); Guillaume Dupont, Toulouse (FR)

(21) Appl. No.: 16/816,721

(22) Filed: Mar. 12, 2020

(30) Foreign Application Priority Data
Mar. 12, 2019 (FR) 1902499

(51) Int. Cl. G08G 5/00; B64C 39/02; G08G 5/04

(52) U.S. Cl. CPC G08G 5/0086; B64C 39/024; B64C 2201/12; B64C 2201/027; G08G 5/045

(57) ABSTRACT

A positioning assistance system for an aircraft in a mission zone comprising a platform offloaded from the aircraft and a flying carrier incorporating the platform. The platform comprises surveillance means for a surveillance zone able to generate surveillance information in real time relative to the surveillance zone, computing means able to analyze the generated surveillance information to deduce route information of the aircraft therefrom, and external communication means able to transmit the route information to the aircraft.

### FIELD OF THE INVENTION

The present invention relates to a positioning assistance system for an aircraft.

The present invention also relates to a flying assembly comprising such a system and an associated positioning assistance method.

In particular, the technical field of the invention is that of precise positioning assistance for an aircraft such as a helicopter or drone, with the aim of securing the flight of the aircraft, and advantageously, the operating perimeter thereof.

### BACKGROUND OF THE INVENTION

In the state of the art, in order to perform precise positioning of an aircraft, the latter is generally provided with a preloaded map of an operating area, allowing its pilot or an automatic piloting system to perform piloting maneuvers to position itself in the operating area.

Terrain avoidance warning systems also exist, which are based on the use of radio-altimetric probes. However, the latter do not provide height information relative to the ground, and do not have the necessary precision for certain positioning maneuvers, such as helihoisting.

For example, for helicopters, the HTAWS (Helicopter Terrain Awareness and Warning System) system is known, which is an obstacle avoidance system, based on preloaded maps and/or radio-altimetric probes.

However, such a map does not account for the vegetation naturally present in the operating perimeter, the real-time weather and real-time changes in terrain configuration (such as landslides, for example) in or around the operating perimeter.

Additionally, this positioning method therefore lacks precision when it is necessary to perform an especially precise operation.

### SUMMARY OF THE INVENTION

The present invention aims to address these drawbacks and therefore to allow an aircraft to perform positioning with a precision that may be in the order of several centimeters.

To that end, the invention relates to a positioning assistance system for an aircraft in a mission zone comprising a platform offloaded from the aircraft and a flying carrier incorporating the platform.

The platform comprises surveillance means for a surveillance zone comprising the mission zone of the aircraft, the surveillance means comprising a plurality of sensors able to generate surveillance information in real time relative to the surveillance zone and the aircraft when it is located in the surveillance zone; computing means able to analyze the surveillance information generated by the surveillance means to deduce route information of the aircraft therefrom, the route information comprising an optimal route of the aircraft in order to access the mission zone and degrees of criticality of maneuvers done in real time by the aircraft on this route; and external communication means able to transmit the route information to the aircraft.

According to other advantageous aspects of the invention, the system comprises one or more of the following features, considered alone or according to all technically possible combinations:
the computing means are further able to determine an optimal observation point of the mission zone when the aircraft is positioned therein, the carrier being able to reach this optimal observation point;
the plurality of sensors comprises a LIDAR;
the computing means are able to build a three-dimensional model of the surveillance zone and a three-dimensional model of the aircraft corresponding to the three-dimensional vector representation of the movements of the aircraft, the three-dimensional model of the surveillance zone advantageously comprising: relief of the terrain, vegetation, artificial obstacles, surrounding climate conditions, unexpected events, and threats.
the computing means are able to determine the degrees of criticality of maneuvers done in real time as a function of likelihoods of collision of the aircraft with obstacles in the surveillance zone by using the three-dimensional model of the surveillance zone and the three-dimensional model of the aircraft;
the likelihoods of collision of the aircraft with objects in the surveillance zone are computed as a function of the number of possible routes to avoid the or each corresponding obstacle and as a function of changes having occurred in the surveillance zone;
at least one of the sensors is able to acquire more surveillance information relative to an at-risk zone compared with other parts of the surveillance zone, the at-risk zone being part of the surveillance zone in which the degree of criticality of at least one maneuver of the aircraft is above a predetermined threshold;
in case of an assistance request from the aircraft, the carrier is able to rejoin an observation point indicated by the aircraft; and the external communication means are further able to send the aircraft surveillance information acquired at that observation point; and
the surveillance means are able to generate surveillance information relative to the surveillance zone before the aircraft arrives in this surveillance zone and the computing means are able to analyze this surveillance information to deduce route information on the arrival of the aircraft therefrom, the route information in particular being relative to the nonstationary path of the aircraft in the surveillance zone.

The invention also relates to a flying assembly comprising an aircraft able to approach a surveillance zone and comprising communication means; at least one positioning assistance system as previously defined making it possible to position the aircraft in a mission zone comprised in the surveillance zone, the external communication means of the positioning assistance system being able to communicate with the communication means of the aircraft.

According to other advantageous aspects of the invention, the assembly comprises one or more of the following features, considered alone or according to all technically possible combinations:
the aircraft further comprises a sound warning able to emit a sound whose frequency and/or period increase(s) with the value of the degree of criticality of the maneuver performed by the aircraft;
the aircraft further comprises a display screen able to display different parts of the surveillance zone differently as a function of the degrees of criticality of the maneuvers of the aircraft that may be implemented in the points making up these different parts; and a prohibited approach zone for the carrier is defined around the aircraft.

The invention also relates to a positioning assistance method for an aircraft in a mission zone implemented by the positioning assistance system as previously described, comprising the following steps:
analyzing the surveillance zone;
determining, as a function of obstacles and/or threats, the optimal route of the aircraft to access the mission zone and sending this route to the aircraft;
joining the optimal observation point; and
performing real-time surveillance of the maneuvers of the aircraft.

### BRIEF DESCRIPTION OF THE DRAWINGS

These features and advantages of the invention will appear upon reading the following description, provided solely as a non-limiting example, and done in reference to the appended drawings.

FIG. 1 is a schematic view of a flying assembly according to the invention, the assembly including an aircraft and a positioning assistance system for the aircraft.

FIG. 2 is a schematic view of a platform of the positioning assistance system of FIG. 1.

FIG. 3 is a flowchart of a positioning assistance method according to the invention, the method being carried out by the system of FIG. 1.

FIG. 4 is a schematic view of a display on a display screen of the aircraft of FIG. 1 following the implementation of the positioning assistance method of FIG. 3.

### DETAILED DESCRIPTION OF THE INVENTION

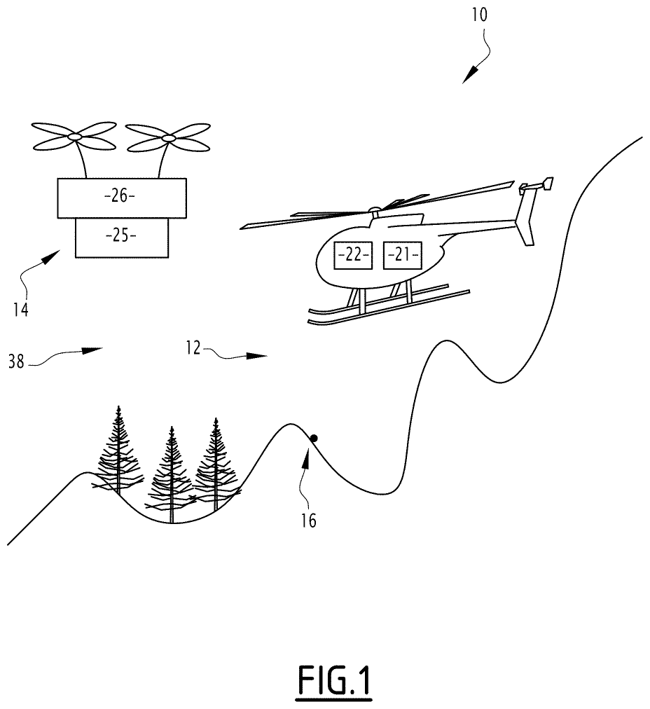

FIG. 1 shows a flying assembly 10 according to the invention. This assembly 10 comprises an aircraft 12 and a positioning assistance system 14 for this aircraft 12.

The aircraft 12 comprises any flying vehicle able to perform a positioning in a mission zone, for example by performing stationary flight. This positioning is for example done at least partially manually by a pilot or automatically, from the cockpit of this aircraft or from a remote piloting center.

In the first case, the aircraft in particular has a helicopter (the case illustrated in FIG. 1). In the second case, the aircraft in particular has a drone.

The mission zone is referenced in FIG. 1 by reference “16” and has any geographical zone in which it is necessary to position the aircraft 12.

Thus, the mission zone 16 can for example have a rescue zone, a landing zone, a work zone, etc.

This mission zone 16 is for example positioned on the ground or near the latter and is for example near natural obstacles (trees or other type of vegetation) and/or artificial obstacles (power cables, electric pylons, other flying vehicles, etc.).

The aircraft 12 comprises communication means 21, and when it is piloted by a pilot, piloting assistance means 22.

The communication means 21 allow the aircraft 12, and in particular a piloting system of this aircraft, to communicate with an external communication system via radio signals, according to a first communication protocol that is known in itself.

The piloting assistance means 22 allow the pilot to pilot the aircraft and for example assume the form of a display screen and/or a sound warning. The operation of these means will described in detail hereinafter.

The positioning assistance system 14 comprises a platform 25 off-board from the aircraft and a carried 26 incorporating this platform 25.

The carrier 26 has a flying vehicle, for example a drone able to be piloted at least partially automatically or automatically, or any other flying vehicle.

According to one exemplary embodiment, the carrier 26 is similar to the aircraft 12.

The platform 25 has a plurality of electronic devices embedded in the carrier 26 so as to implement the operation of the positioning assistance system 14.

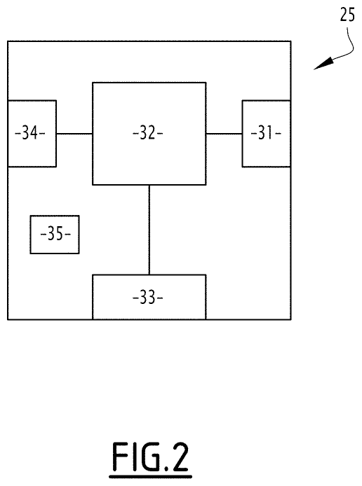

In particular, in reference to FIG. 2, the platform 25 comprises surveillance means 31, computing means 32, external communication means 33, internal communication means 34 and supply means 35.

The surveillance means 31 comprise a plurality of sensors making it possible to monitor a surveillance zone 38 as well as the position of the carrier 26 in this surveillance zone 38.

The surveillance zone 38 comprises a part of the space in which the carrier 26 is located and in which the surveillance carried out by the means 31 is possible.

Thus, for example, in the example of FIG. 1, the surveillance zone 38 corresponds to the entire part visible in this FIG. 1.

Furthermore, the mission zone 16 is defined in this surveillance zone 38 as will be explained hereinafter.

The sensors making up the surveillance means 31 are able to generate surveillance information relative to the surveillance zone 38 and/or the evolution of the carrier 26 and the aircraft 12 in this surveillance zone 38 and to transmit this information to the computing means 32.

These sensors in particular comprise an inertial unit, an altimeter, a geolocation sensor and a LIDAR.

The inertial unit comprises an accelerometer and a gyrometer that are able to provide information respectively relate to the linear and angular accelerations of the carrier 26. This information makes it possible to determine the current attitude of the carrier 26.

The altimeter makes it possible to provide information relative to the current altitude of the carrier 26.

The geolocation sensor for example has a sensor for GPS (Global Positioning System) signals that is able to provide the geographical position of the carrier 26 in real time.

The LIDAR makes it possible to take three-dimensional readings of the space using a laser and thus makes it possible to build a map of the surveillance zone 38 using methods known in themselves.

In particular, according to the invention, the lidar can be positioned in azimuth and elevation and is equipped with a three-axis stabilizer to compensate the movements of the carrier 26. It for example makes it possible to perform readings with a precision on the order of a centimeter or several centimeters.

Each of the aforementioned sensors is further able to generate state information relative to the state of its operation and to send this information to the computing means 32.

According to other exemplary embodiments, the surveillance means 31 comprise, in addition to the LIDAR, any other sensor known in itself, such as a camera, in particular an infrared camera, etc.

The computing means 32 at least partially assume the form of a computer comprising a processor and memory, and/or one or several programmable logic circuits, for example of the FPGA (Field-Programmable Gate Array) type.

The computing means 32 are able to receive surveillance information coming from the surveillance means 31, analyze this information and deduce route information intended for the aircraft 12 therefrom. This route information will be described in detail hereinafter.

The computing means 32 are further able to control the operation of the surveillance means 31 and in particular to receive state information coming from these surveillance means 31 in order to deduce the operating state of each sensor.

From the surveillance information, the computing means 32 are further able to generate path information relative to the path to be followed by the carrier 26, as will be explained hereinafter.

The external communication means 33 have radio communication means such as a transceiver for radio signals able to communicate with an external communication system such as the communication means 21 of the aircraft 12, via radio signals, by using a communication protocol known in itself.

In particular, the external communication means 33 are able to send the aircraft 12 route information generated by the computing means 32.

The external communication means 33 are further able to receive an assistance request emitted by the aircraft 12 and to send it to the computing means 32.

The external communication means 33 are further able to receive configuration information coming from an external system.

This configuration information in particular includes configuration information of the aircraft 12 and its mission.

The internal communication means 34 have a communication interface with the carrier 26, and in particular with a piloting system thereof.

Thus, these internal communication means 34 are able to send the carrier 26 path information generated by the computing means 32.

The internal communication means 34 are able to send the computing means 32 information relative to the operation of the various components of the carrier 26 as well as information relative to the compensations of the carrier done in order to keep its route and its position. This information is generated by the carrier 26, for example by the piloting system thereof.

Furthermore, when at least some of the aforementioned components of the platform 25 (such as a sensor) are part of the carrier, the internal communication means 34 make it possible to send information generated by these components to the computing means 32 or then, information generated by these computing means 32 and intended for these components.

Lastly, the power supply means 35 for example have a battery able to power all of the components of the platform 25. These power supply means 35 are also able to send the computing means 32 information relative to their operating state.

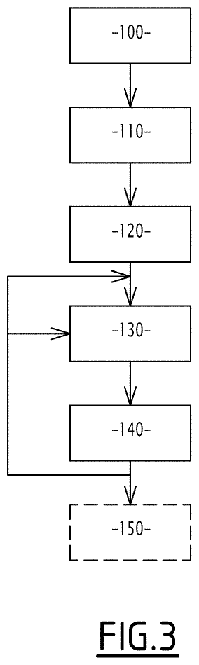

The positioning assistance system 14 makes it possible to carry out the positioning assistance method according to the invention. This method will now be explained in reference to FIG. 3, showing a flowchart of its steps.

At the beginning of the mission, the positioning assistance system 14 carries out a configuration step 100.

In particular, during this step 100, the computing means 32 receive, via external/internal communication means 33, 34, configuration information relative to the carrier 26 and the aircraft 12.

This configuration information in particular includes: carrier characteristics; aircraft characteristics; information relative to the surveillance zone 38; information relative to the mission zone 16; information relative to a no-fly zone around the aircraft 12; admissibility threshold; and no-fly zone of the perimeter around the aircraft.

The carrier characteristics in particular comprise flight characteristics and physical characteristics of the perimeter 26.

The flight characteristics allow the computing means 32 to compute the path of the carrier 26 in order to reach a point as a function of the speed, weather conditions and relief.

The physical characteristics include information relative to the physical configuration of the carrier 26. This configuration for example indicates whether the carrier incorporates at least one sensor and/or radio communication means that can be used by the platform 25.

The aircraft characteristics allow the computing means 32 to compute the path of the aircraft 12 in order to reach a point as a function of the speed and weather conditions. These characteristics make it possible, owing to the LIDAR and to a shape recognition algorithm, to extract and identify the aircraft 12 with respect to the rest of the surveillance zone 38. These characteristics thus form a three-dimensional model of the aircraft 12 corresponding to the three-dimensional vectorial representation of the movements of the aircraft 12.

The information relative to the surveillance zone 38 comprises an area formula making it possible to constitute the geographical coordinates defining a volume to be surveilled. A consistency check of these data can be done by the computing means 32. This check is for example based on the analysis of the LIDAR performances and the autonomy of the carrier 26.

The information relative to the mission zone 16 comprises the coordinates of a geographical point or an area formula making it possible to constitute the geographical coordinates to perform a shape recognition of the aircraft 12 to be surveilled.

The information relative to the no-fly zone makes it possible to define a prohibited approach area for the carrier 26 around the aircraft 12. This information comprises a formula constituting an area around the aircraft 12.

The admissibility threshold corresponds to the maximum hazard allowance of the maneuvers performed by the aircraft 12. This threshold conditions the calculation of the degree of criticality of each maneuver, explained in detail hereinafter.

It should be noted that this configuration step can be carried out at least partially during the mission of the carrier 26, that is to say, during the performance of steps 110 to 140, explained in detail hereinafter. This new implementation is carried out in particular if information is received relative to the surveillance zone 38 and/or the mission zone 16.

It should lastly be noted that this configuration step 100 can further comprise the configuration of the system 14 in case of reception of an assistance request coming from the aircraft 12.

In this case, the mission of the system 14 changes. This mission consists of no longer surveilling the aircraft 12, but of sending it information (in particular threats) for example acquired by at least some of the sensors of the platform 25, such as by the LIDAR. This information can for example be acquired from a position of the carrier 26 requested by the aircraft 12.

During the following step 110, the computing means 32 activate the operation of the surveillance means 31, which then generate surveillance information relative to the surveillance zone 38.

This surveillance information is next sent to the computing means 32, which perform their analysis.

In particular, during this step 110, the computing means 32 build a three-dimensional model of the surveillance zone 38 advantageously comprising: relief of the terrain; vegetation; artificial obstacles; surrounding climate conditions; unexpected events; and threats (hidden shooter, missile launch, etc.).

During the following step 120, the computing means 32 place the mission zone 16 in the surveillance zone 38 and determine an optimal route of the aircraft 12 in order to access the mission zone 16 via the surveillance zone 38.

This optimal route corresponds to a route allowing the aircraft 12 to access the mission zone 16 with a minimal danger.

The optimal route and the positioning of the mission zone 16 are determined as a function of characteristics of the aircraft 12.

Then, at the end of this step 120, the optimal route is sent to the aircraft 12 via the external communication means 33 in the form of route information.

During the following step 130, the computing means 32 determine an optimal observation point of the mission zone 16. This point corresponds to a point in space ensuring better observability of the mission zone 16, while being located at a distance from the optimal route computed during step 120.

Then, the computing means 32 determine a path of the carrier 26 in order to reach this point and send this path via the internal communication means 34 to the carrier 26.

The carrier 26 then rejoins the optimal observation point.

During the following step 140, the system 14 performs the real-time surveillance of the maneuvers performed by the aircraft 12 in or near the mission zone 16, from the optimal observation point.

This surveillance is in particular done as a function of the attitudes of the aircraft 12. To that end, the computing means 32 determine a three-dimensional model of the aircraft 12 in the surveillance zone in particular with readings done by LIDAR and aircraft characteristics.

Then, the computing means 32 perform a real-time analysis of this three-dimensional model of the aircraft 12 relative to the three-dimensional model of the surveillance zone 38 to deduce therefrom the degree of criticality of each maneuver performed by the aircraft 12.

In particular, the degree of criticality of each maneuver is determined as a function of the likelihoods of collision of the aircraft 12 with an obstacle during this maneuver. Each degree of criticality is for example next compared with the admissibility threshold defined during the configuration step 100.

The likelihoods of collision are computed as a function of the number of possible routes avoiding the obstacle in the surveillance zone 38, in light of the movement of the aircraft 12 and environmental changes: proximity of obstacles, weather changes, etc.

To that end, according to one exemplary embodiment, the aircraft 12 is projected in the surveillance zone 38 by using the respective three-dimensional models and is surrounded by a point cloud. Then, for each point of the cloud of points, the distance is computed relative to the closest obstacle as a function of various parameters:
flight parameters of the aircraft: speed vector, acceleration vector, altitude, horizontal position, vertical position, azimuth, heading, etc.;
parameters that may cause variations in the position of the aircraft: wind speed vector, acceleration vector; and
aircraft characteristics.

Added to this depiction are the parameters of unexpected events coming from the surveillance zone 38: speed vector and position of any object that may collide with the aircraft in the mission zone.

The point cloud is not constant. It is influenced by the accelerations of the different parts of the aircraft and the parameters of unexpected events. The greater the acceleration is, the more this part of the aircraft is projected in space, the greater the risk of collision is with an unexpected event, the more this threat is projected. The time before the collision of part of the aircraft with an obstacle or an unexpected event is also extracted from this representation.

The possible exit routes are computed from the point cloud. In particular, these exit routes correspond to routes on which the aircraft 12 can perform obstacle avoidance maneuvers as a function of:
flight parameters of the aircraft: speed vector, acceleration vector, altitude, horizontal position, vertical position, azimuth, heading, etc.;
parameters that may cause variations in the position of the carrier 26: wind speed vector, acceleration vector;
unexpected parameters: speed vector and position of any object that may collide with the aircraft;
the distance relative to the obstacles; and
aircraft characteristics.

According to one advantageous exemplary embodiment of the invention, the calculation of the possible exit routes is done by an artificial intelligence model supplied by the three-dimensional model of the aircraft and its flight capabilities as a function of different usage contexts. This artificial intelligence model is built on a neural network that is supplied by situation simulations. Advantageously, this model can simultaneously learn the terrain as a function of maneuvers by the aircraft to leave a zone where the degree of criticality of the maneuvers is high.

Furthermore, according to still another advantageous exemplary embodiment of the invention, the computing means 32 control at least one of the sensors of the surveillance means 31, for example the LIDAR, in order to acquire still more surveillance information relative to an at-risk zone compared with other parts of the surveillance zone.

The at-risk zone is defined as a part of the surveillance zone 38 in which the degree of criticality of at least one maneuver of the aircraft is above a predetermined threshold.

At the end of step 140, the degree of criticality of the maneuver implemented in real time by the aircraft 12 is sent to the aircraft 12 via the external communication means 33 in the form of route information.

Then, step 140 is implemented again for each new maneuver performed by the aircraft 12. The surveillance of the maneuvers of the aircraft 12 is thus performed in real time.

Furthermore, step 130 can also be carried out again in order to determine a new optimal observation position of the mission zone 16. In this case, the carrier 26 then rejoins this position and step 140 is carried out from this position.

According to one advantageous exemplary embodiment of the invention and in particular when the aircraft 12 is piloted by a pilot, upon reception of each degree of criticality of the corresponding maneuver, the latter is communicated to the pilot in particular via the piloting assistance means 22.

Thus, for example, in this case, the sound warning of the aircraft 12 is configured to emit a sound whose frequency and/or period increase(s) with the value of the degree of criticality of the maneuver performed by the aircraft 12.

According to still another exemplary embodiment, the display screen of the aircraft 12 is configured to schematically display the surveillance zone 38 on which different parts are shown differently as a function of the degrees of criticality of the maneuvers of the aircraft that may be performed in the points making up these different parts.

Thus for example, three different parts can be defined in the display of the surveillance zone 38. These parts can be defined as follows:
risk-free maneuvers part: the pilot of the aircraft 12 can maneuver freely without worrying about obstacles;
restricted maneuvers part: the pilot of the aircraft must be attentive to his maneuvers and has fewer options for maneuvering in particular if the environmental conditions change; and
dangerous part: the aircraft is structurally in danger and has no avoidance maneuvers if conditions change.

These various parts can for example be shown by using different colors. For example, the risk-free part can be shown in green, the restricted maneuvers part in yellow and the dangerous part in red.

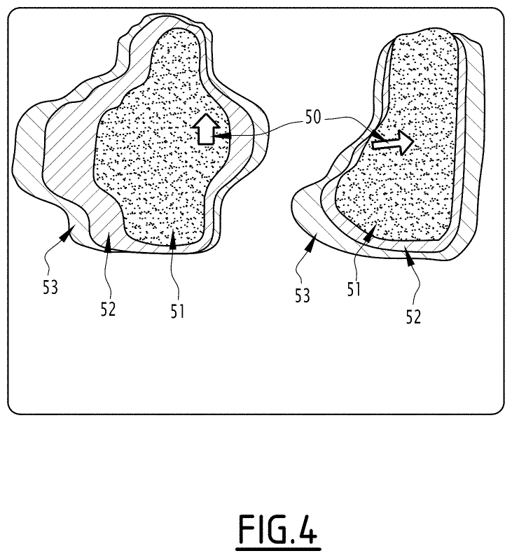

One example of such a display is shown in FIG. 4.

In particular, in this FIG. 4, a vertical view is shown on the left and a horizontal view is shown on the right, the position and the movement direction of the aircraft 12 being shown by the arrow 50.

In this figure, the risk-free maneuvers part is referenced by reference “51”, the restricted maneuvers part by reference “52” and the dangerous part by reference “53”.

Of course, other display modes, or more generally pilot warning modes, are also possible.

Advantageously, the method according to the invention further comprises a step 150 implemented upon receiving an assistance request from the aircraft 12.

In this case, the system 14 abandons its surveillance mission and the carrier 26 moves into the position sent for example with the assistance request or computed by the computing means 32.

In this position, the surveillance means 31, in particular the LIDAR, generate surveillance information that is next sent to the aircraft, where it is for example shown in a graphic form on the display screen.

The pilot of the aircraft 12 can thus have “an exterior view” on the aircraft 12 from the desired position.

Other embodiments of the invention are also possible.

In particular, it is clear that several positioning assistance systems can be used to surveil an aircraft. In this case, these systems can communicate with one another in order to take different positions near the aircraft to thus provide better surveillance thereof.

Furthermore, one or several positioning assistance systems can simultaneously surveil several aircraft.

One can then see that the present invention has a certain number of advantages.

First, the positioning assistance system according to the invention makes it possible to position an aircraft especially precisely in a mission zone. This mission zone can have changing conditions (weather or other) as well as unexpected events.

To that end, the system makes it possible to provide “an exterior view” of each maneuver performed by the aircraft.

Additionally, the pilot or the automatic piloting system of the aircraft remains informed regarding the criticality of each maneuver performed, which makes it possible to secure the implementation of the approach of the mission zone considerably.

Lastly, the system according to the invention makes it possible to satisfy an assistance request emitted by the aircraft and can thus be used outside its main mission.

1. A positioning assistance system for an aircraft in a mission zone, the positioning assistance system comprising:
a platform offloaded from the aircraft; and
a flying carrier incorporating the platform;
wherein the platform comprises:
surveillance modules for a surveillance zone comprising the mission zone of the aircraft, the surveillance modules comprising a plurality of sensors able to generate surveillance information in real time relative to the surveillance zone and the aircraft when it is located in the surveillance zone;
computing modules able to analyze the surveillance information generated by the surveillance modules to deduce route information of the aircraft therefrom, the route information comprising an optimal route of the aircraft in order to access the mission zone and degrees of criticality of maneuvers done in real time by the aircraft on this route, the computing modules being able to build a three-dimensional model of the surveillance zone and a three-dimensional model of the aircraft corresponding to the three-dimensional vectorial representation of the movements of the aircraft, the three-dimensional model of the surveillance zone comprising:
relief of the terrain, vegetation, artificial obstacles, surrounding climate conditions, unexpected events, and threats;
the computing modules being able to determine the degrees of criticality of maneuvers done in real time as a function of likelihoods of collision of the aircraft with obstacles in the surveillance zone by using the three-dimensional model of the surveillance zone and the three-dimensional model of the aircraft; and
external communication modules able to send the route information to the aircraft.

2. The positioning assistance system according to claim 1, wherein the computing modules are further able to determine an optimal observation point of the mission zone when the aircraft is positioned therein, the carrier being able to reach this optimal observation point.

3. The positioning assistance system according to claim 1, wherein the plurality of sensors comprises a LIDAR.

4. The positioning assistance system according to claim 1, wherein the likelihoods of collision of the aircraft with objects in the surveillance zone are computed as a function of the number of possible routes to avoid the or each corresponding obstacle and as a function of changes having occurred in the surveillance zone.

5. The positioning assistance system according to claim 1, wherein at least one of the sensors is able to acquire more surveillance information relative to an at-risk zone compared with other parts of the surveillance zone, the at-risk zone being part of the surveillance zone in which the degree of criticality of at least one maneuver of the aircraft is above a predetermined threshold.

6. The positioning assistance system according to claim 1, wherein in case of an assistance request from the aircraft:
the carrier is able to rejoin an observation point indicated by the aircraft; and
the external communication modules are further able to send the aircraft surveillance information acquired at that observation point.

7. The positioning assistance system according to claim 1, wherein the surveillance modules are able to generate surveillance information relative to the surveillance zone before the aircraft arrives in this surveillance zone and the computing modules are able to analyze this surveillance information to deduce route information on the arrival of the aircraft therefrom, the route information in particular being relative to the nonstationary path of the aircraft in the surveillance zone.

8. A flying assembly comprising:
an aircraft able to approach a surveillance zone and comprising communication modules; and
at least one positioning assistance system according to claim 1 making it possible to position the aircraft in a mission zone comprised in the surveillance zone, the external communication modules of the positioning assistance system being able to communicate with the communication modules of the aircraft.

9. The flying assembly according to claim 8, wherein the aircraft further comprises a sound warning able to emit a sound whose frequency and/or period increase(s) with the value of the degree of criticality of the maneuver performed by the aircraft.

10. The flying assembly according to claim 8, wherein the aircraft further comprises a display screen able to display different parts of the surveillance zone differently as a function of the degrees of criticality of the maneuvers of the aircraft that may be implemented in the points making up these different parts.

11. The flying assembly according to claim 8, wherein a prohibited approach zone for the carrier is defined around the aircraft.

12. A positioning assistance method for an aircraft in a mission zone implemented by the positioning assistance system according to claim 2, comprising the following steps:
analyzing the surveillance zone;
determining, as a function of obstacles and/or threats, the optimal route of the aircraft to access the mission zone and sending this route to the aircraft;
joining the optimal observation point; and
performing real-time surveillance of the maneuvers of the aircraft.
